(19) United States
(12) Patent Application Publication
(10) Pub. No.: US 2016/0182404 A1
(43) Pub. Date: Jun. 23, 2016

(54) CONTROLLING ACCESS AND BEHAVIOR BASED ON TIME AND LOCATION

(71) Applicants: Ashutosh Rastogi, Bangalore (IN); Dharmesh Rana, Nadiad (IN); Vikas Kumar Yadav, Bangalore (IN)

(72) Inventors: Ashutosh Rastogi, Bangalore (IN); Dharmesh Rana, Nadiad (IN); Vikas Kumar Yadav, Bangalore (IN)

(21) Appl. No.: 14/579,087

(22) Filed: Dec. 22, 2014

(51) Int. Cl. H04L 12/911; H04L 29/08

(52) U.S. Cl. CPC H04L 47/829; H04L 47/826; H04L 67/18; H04L 67/16

(57) ABSTRACT

The present disclosure involves systems, software, and computer implemented methods for controlling access and behavior of content based on a time and location of attempted access. In one example, a method may include receiving a request to provide content or application access to a user, identifying at least one behavior modification rule associated with the requested content or application access, the at least one behavior modification rule associated with a particular user context, identifying a user context associated with the requesting user, and, in response to determining that the identified user context is within the particular user context associated with the at least one behavior modification rule, performing the at least one behavior modification rule associated with the requested content or application access. The particular user context associated with the at least one behavior modification rule may be based on a location and/or time associated with the user context.

### TECHNICAL FIELD

The present disclosure relates to computer systems and computer-implemented methods for controlling access and behavior of content based on a time and location of attempted access.

Sensitive data is, by definition, required to be restricted to authorized users and prohibited from access by random users. Typical solutions using authentication and authorization schemes, such as user credentials, are used throughout organizations. Private and public key cryptography and other security mechanisms may be used to prevent unwanted access. Multi-layer security systems may also be used to prevent access.

### SUMMARY

The present disclosure involves systems, software, and computer-implemented methods for controlling access and behavior of content based on a time and location of attempted access. In one example, a method may include receiving a request to provide content or application access to a user, identifying at least one behavior modification rule associated with the requested content or application access, the at least one behavior modification rule associated with a particular user context, identifying a user context associated with the requesting user, and, in response to determining that the identified user context is within the particular user context associated with the at least one behavior modification rule, performing the at least one behavior modification rule associated with the requested content or application access. The particular user context associated with the at least one behavior modification rule may be based on a location and/or time associated with the user context. [0004] While generally described as computer-implemented software embodied on non-transitory, tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for controlling access and behavior of content based on a time and location of attempted access.

FIG. 2 is an illustration of example operations performed to provide a time- and/or location-based access restriction to content based on a user context.

FIG. 3 is a flowchart of an example operation performed to provide time- and/or location-based behavioral modifications to content and/or application operations based on a user context.

FIG. 4 is a flowchart of an example operation for identifying the location of the user associated with the user context.

### DETAILED DESCRIPTION

The present disclosure describes a system for modifying the presentation of content based on a user context. Organizations may wish to provide additional security to content and applications in addition to commonly used authentication and verification schemes. For example, organizations may want to restrict the access to otherwise valid (i.e., authenticated and authorized) users at certain times or locations, as well as to control certain behaviors of content and/or applications presenting that content at a certain location event and/or at a certain time.

In a first example, a technical presentation of a large multi-national company is considered. During the three-day event, which runs from 9 AM to 12 PM across different locations across the globe, the company may wish to publish deals or other content to users participating in the events. However, the deals may be only available to them at the location of the event and during the event's normal hours.

In a second example, an event running from 9 AM to 5 PM on a particular day and at a particular location is considered, such as an event introducing, and allowing interaction with, new software or online products. The organization associated with such an event may want to limit access to computer systems and/or software operating on such systems to provide access only during the time and at the location of the event.

In a third example, a company may provide additional online materials in connection with a product launch event. The online materials may be limited to the time of the event and the location of the presentation, allowing the presenters to provide real-time user demonstrations and further documentation while limiting the accessibility of the material to those in attendance.

In a fourth example, certain actions may be performed locally all over the world in which access to particular material is relatively sensitive and requires restricted use. For example, a legal source code review may be performed across several offices of a particular law firm. Access to the source code may be limited to local business hours at those locations (e.g., 9 AM to 5 PM, locally) and may be geo-fenced or otherwise available only within the law firm's offices. In some instances, access may be limited to particular rooms within the offices via one or more techniques to ensure sensitive materials are not removed or accessed outside from the controlled area.

The present solution provides means to restrict or modify the delivery of content to an otherwise valid (i.e., authenticated and/or authorized) user, such that an otherwise authorized application and/or device is controlled to behave in a particular way based on the location and time of the attempted accessing. The behavior rules determining whether access is allowed and/or how the content is presented can be embedded within the content itself (e.g., where the content is stored at a mobile device), included in one or more rule sets associated with the content, determined by a local application (e.g., a mobile application executed at the mobile device), or determined by a backend or remote application based on a request for content from the backend application.

The location of the attempted access can be determined by a plurality of methods, including, but not limited to, a determination of location through a global positioning system (GPS) of a GPS-enabled device (e.g., smartphones, wearable devices, etc.), beacons for devices having receivers (e.g., iBeacon for Apple devices), geo-fencing of an area, near-field communications (NFC), IP addresses for network-enabled devices, connected networks (i.e., availability of a particular wireless or wired network), as well as others. The timing of the access can be determined using local timing information, a current time zone as determined via GPS or other location determination associated with the device, absolute time information retrieved from a world time server, or others. In some instances, the timing of the accessing may be relevant not to the user, but rather to a time period defined by the content provider, such as when product information or material is made available at a particular time local to the content provider, but that is made available worldwide or otherwise outside of the local time zone. Time-based restrictions or contexts may be defined for particular times, such as a range of days, regular business days (e.g., working days, not holidays or weekends), month restrictions, year restrictions, and any other suitable times.

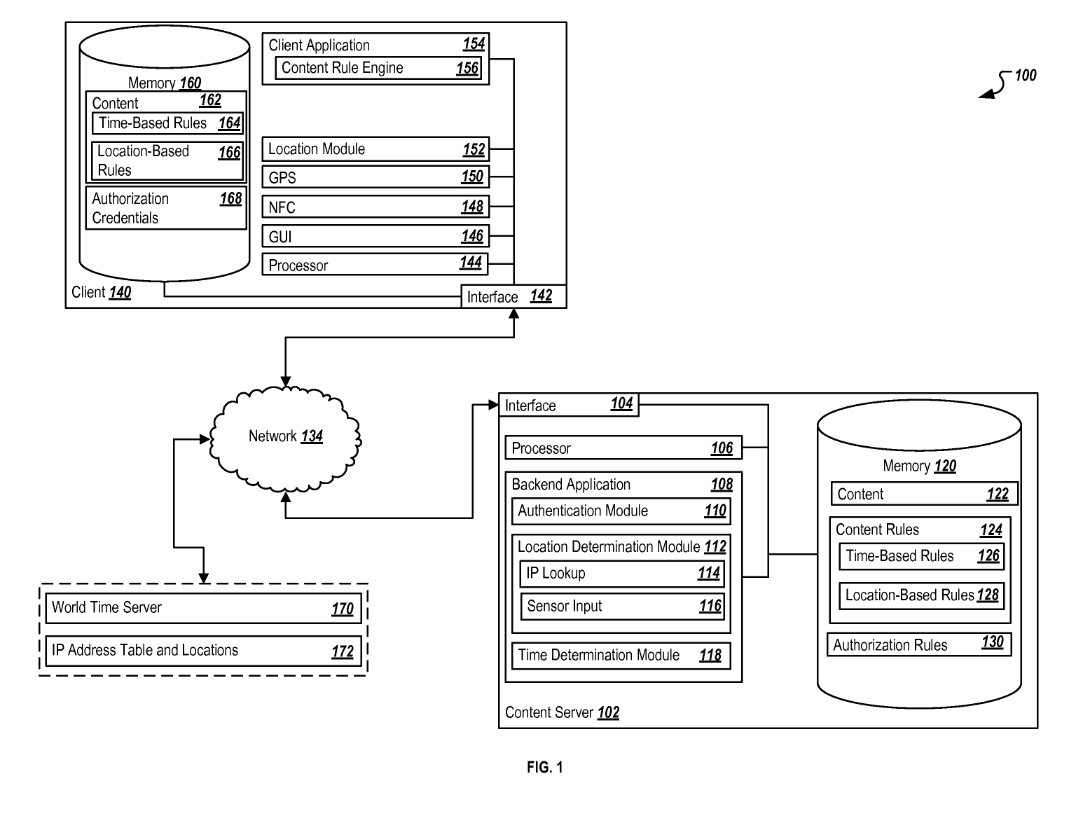

Turning to the illustrated embodiment, FIG. 1 is a block diagram illustrating an example system 100 for controlling access and behavior of content based on a time and location of attempted access. As illustrated in FIG. 1, system 100 is a client-server system capable of providing content that can be associated with rules based on a time and location, where the rules can modify the behavior of the content (or application providing the content) and/or the accessing of the content (or application providing the content). In some instances, a client system alone may be sufficient to perform the operations of the system 100, such as when content stored locally on the client is associated with content-related rules. In other instances, content may be requested from a backend server (e.g., content server 102), such that the server makes decisions and determinations as to whether the content or its behavior is to be modified. Specifically, system 100 as illustrated includes or is communicably coupled with a client 140, content server 102, network 134, a world time server 170, and a server 172 containing IP addresses and corresponding locations. Although components are shown individually, in some implementations, functionality of two or more components, systems, or servers may be provided by a single component, system, or server. Similarly, in some implementations, the functionality of one illustrated component, system, or server may be provided by multiple components, systems, servers, or combinations thereof. Conversely, multiple components may be combined into a single component, system, or server, where appropriate.

As used in the present disclosure, the term “computer” is intended to encompass any suitable processing device. For example, content server 102 may be any computer or processing device such as, for example, a blade server, general-purpose personal computer (PC), Mac®, workstation, UNIX-based workstation, or any other suitable device. Moreover, although FIG. 1 illustrates content server 102 as a single system, content server 102 can be implemented using two or more systems, as well as computers other than servers, including a server pool. In other words, the present disclosure contemplates computers other than general-purpose computers, as well as computers without conventional operating systems. Further, illustrated content server 102, client 140, world time server 170, and the server 172 containing IP addresses and corresponding locations may each be adapted to execute any operating system, including Linux, UNIX, Windows, Mac OS®, Java™, Android™, or iOS. According to one implementation, the illustrated systems may also include or be communicably coupled with a communication server, an e-mail server, a web server, a caching server, a streaming data server, and/or other suitable server or computer.

In general, content server 102 may be any suitable backend computing server or system storing content (e.g., content 122) for presentation to users in response to requests for the same. The content server 102 is described herein in terms of responding to requests for presentation of content from users at client 140 and other clients. However, the content server 102 may, in some implementations, be a part of a larger system providing additional functionality. For example, content server 102 may be part of an enterprise business application or application suite providing one or more of enterprise relationship management, content management systems, customer relationship management, and others.

The illustrated content server 102 can store content 122 and, in response to requests from clients 140, provide the content 122 via responsive communications. In some instances, the content server 102 may store content 122 that is associated with one or more rules that control the behavior or accessibility of the content 122, such as time-based rules 126 or location-based rules 128, as well as other suitable content rules 124. In some instances, the content server 102 can receive requests for specific content 122 and evaluate whether the associated rules are satisfied. Such determinations may require additional information regarding the client 140 and its current client context to be determined before the evaluation can be made. In response to a determination that one or more content-related rules are met, the content server 102 can restrict or provide access to particular content 122 or modify the behavior or presentation of the content 122.

As illustrated, content server 102 includes an interface 104, a processor 106, a backend application 108, and memory 120. In general, the content server 102 is a simplified representation of one or more systems and/or servers that provide the described functionality, and is not meant to be limiting, but rather an example of the systems possible.

The interface 104 is used by the content server 102 for communicating with other systems in a distributed environment—including within the environment 100—connected to the network 134, e.g., client(s) 140 and other systems communicably coupled to the network 134. Generally, the interface 104 comprises logic encoded in software and/or hardware in a suitable combination and operable to communicate with the network 134. More specifically, the interface 104 may comprise software supporting one or more communication protocols associated with communications such that the network 134 or interface's hardware is operable to communicate physical signals within and outside of the illustrated environment 100.

Network 134 facilitates wireless or wireline communications between the components of the environment 100 (i.e., between the content server 102 and client(s) 140, between clients 140, and among others), as well as with any other local or remote computer, such as additional clients, servers, or other devices communicably coupled to network 134, including those not illustrated in FIG. 1. In the illustrated environment, the network 134 is depicted as a single network, but may be comprised of more than one network without departing from the scope of this disclosure, so long as at least a portion of the network 134 may facilitate communications between senders and recipients. In some instances, one or more of the illustrated components may be included within network 134 as one or more cloud-based services or operations. For example, one or both of the world time server 170 and/or the server 172 storing the IP address table may be cloud-based services. The network 134 may be all or a portion of an enterprise or secured network, while in another instance, at least a portion of the network 134 may represent a connection to the Internet. In some instances, a portion of the network 134 may be a virtual private network (VPN). Further, all or a portion of the network 134 can comprise either a wireline or wireless link. Example wireless links may include 802.11ac/ad,/af/a/b/g/n, 802.20, WiMax, LTE, and/or any other appropriate wireless link. In other words, the network 134 encompasses any internal or external network, networks, sub-network, or combination thereof operable to facilitate communications between various computing components inside and outside the illustrated environment 100. The network 134 may communicate, for example, Internet Protocol (IP) packets, Frame Relay frames, Asynchronous Transfer Mode (ATM) cells, voice, video, data, and other suitable information between network addresses. The network 134 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the content server 102 includes a processor 106. Although illustrated as a single processor 106 in FIG. 1, two or more processors may be used according to particular needs, desires, or particular implementations of the environment 100. Each processor 106 may be a central processing unit (CPU), an application-specific integrated circuit (ASIC), a field-programmable gate array (FPGA), or another suitable component. Generally, the processor 106 executes instructions and manipulates data to perform the operations of the content server 102. Specifically, the processor 106 executes the algorithms and operations described in the illustrated figures, including the operations performing the functionality associated with the content server 102 generally, as well as the various software modules (e.g., the backend application 108), including the functionality for sending communications to and receiving transmissions from client(s) 140.

The backend application 108 represents an application, set of applications, software, software modules, or combination of software and hardware used to perform operations related to presenting and executing content 122. In the present solution, the backend application 108 can perform operations including receiving requests for particular content 122, evaluating the request and a user context associated with the request, identifying particular content rules 124, and providing the requested content 122 based on the evaluation and application of the rules 124. The backend application 108 can include and provide various functionality to assist in the management and execution of providing the requested content 122. As illustrated in FIG. 1, the backend application 108 includes an authentication module 110, a location determination module 112, and a time determination module 118. By using information derived by these modules, the backend application 108 can determine what content 122 is to be presented in response to users' requests. Additional modules and functionality may be included in alternative implementations.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

The authentication module 110 can provide functionality associated with authenticating a particular user requesting content 122. In many instances, regardless of a particular user being authenticated or otherwise authorized to access particular content 122 generally, the corresponding content rules 124 can determine whether and how the content 122 will be provided based on the authorized user's particular context. The authentication module 110 can accept or identify credentials of a requesting user associated with client 140 (or accessing the backend application 108 at the content server 102) and use the set of authorization rules 130 stored in memory 120 to verify said credentials.

The location determination module 112 performs operations associated with identifying a particular location of the client 140. In some instances, location information may not be explicitly included in a request for content 122. The location determination module 112 can use one of various techniques to assist in determining the location of the client 140. As illustrated, the location determination module 112 includes an IP lookup module 114 and a sensor input module 116. The IP lookup module 114 can be used to identify an IP address associated with the request for content 122 and determine a location based upon the IP address. For example, the IP lookup module 114 may be able to query a server 172 storing IP addresses and their associated locations. Using this information, the location determination module 112 can identify the location of the client 140 based on the IP address.

The sensor input module 116 can be used to identify, via one or more sensors at or associated with the content server 102, a location of the client 140. For example, the sensor input module 116 can be associated with one or more iBeacons or other beacon-like sensor. iBeacons allow devices to find their relative location to an iBeacon or other beacon within an environment (e.g., a store). An iBeacon deployment consists of one or more iBeacon devices (e.g., a device associated with content server 102) that transmit their own unique identification number to the local area. Software on a receiving device (i.e., client 140) may then look up the iBeacon and perform various functions, such as notifying the user or otherwise providing information on the receiving device's location. Receiving devices can also connect to the iBeacon devices to retrieve values from the iBeacon device's GATT (generic attribute profile) service.

In other instances, the sensor input module 116 may be associated with other location-based sensors, including a near-field communication (NFC) sensor. NFC is a form of short-range wireless communication where the antenna used is much smaller than the wavelength of the carrier signal (thus preventing a standing wave from developing within the antenna). In the near-field (approximately one quarter of a wavelength), the antenna can produce either an electric field or a magnetic field, but not an electromagnetic field. Thus, NFC communicates either by a modulated electric field or by a modulated magnetic field, but not by radio (electromagnetic waves). Mobile devices (e.g., client 140) capable of NFC communications can communicate in close proximity to an NFC receiver or device to identify when such mobile devices are available. When they are, the proximity can trigger one or more location-based rules 128. Alternatively, the sensor input module 116 may be associated with a radio frequency identifier (RFID) system to determine when an RFID tag associated with client 140 is within range of the RFID sensor associated with content server 102. It is noted that the sensor input module 116 does not require sensors to be physically attached to the content server 102, but may include input received from one or more remote sensors (not illustrated). By doing so, remote presentations of content 122 can be managed without requiring client 140 to be physically close to the content server 102, but instead one or more sensors associated with the content server 102.

In some instances, information defining the client's 140 location may be included within the request. For example, the request may include specific GPS coordinates or other explicit location information. Using that information, and if the requested content 122 is associated with any location-based rules 128, the location determination module 112 or backend application 108 itself can determine if the identified location is within the locations identified by the location-based rules 128.

As illustrated, backend application 108 includes the time determination module 118. The time determination module 118 can be used to determine a time associated with the request for particular content 122. The determined time may be relevant to the location of the client 140 (i.e., local time based on the time zone) when time-based rules 126 define time-based rules specific to the location of the client 140, or may be relevant to an absolute time as identified by the rule (e.g., a time in a particular time zone, regardless of the local time for the client 140). In some instances, the time associated with the request may be included in the request itself. Alternatively, the time determination module 118 may access a world time server 170 or use any other suitable time determination technique, including using a local time to the content server 102 to determine the current time, while using one of the location determination techniques to adapt the local time at the content server 102 to the local time at the requesting client 140. In some instances, the time-based rules may include rules associated with particular times in a day as well as particular days (e.g., weekdays vs. weekends, particular individual or sets of days, etc.). Further, the time-based rules may be associated with time relative to an event, such as a set period of time after a triggering event (e.g., a user action, a third-party action, etc.) occurs.

As illustrated, content server 102 includes memory 120, or multiple memories 120. The memory 120 may include any memory or database module and may take the form of volatile or non-volatile memory including, without limitation, magnetic media, optical media, random access memory (RAM), read-only memory (ROM), removable media, or any other suitable local or remote memory component. The memory 120 may store various objects or data, including financial and/or business data, user information, behavior and access rules, administrative settings, password information, caches, applications, backup data, repositories storing business and/or dynamic information, and any other appropriate information including any parameters, variables, algorithms, instructions, rules, constraints, or references thereto associated with the purposes of the backend application 108 and/or content server 102. Additionally, the memory 120 may store any other appropriate data, such as VPN applications, firmware logs and policies, firewall policies, a security or access log, print or other reporting files, as well as others. For example, illustrated memory 120 includes content 122, content rules 124, and authorization rules 130.

Content 122 may include static and/or dynamic content. Additionally, content 122 may be data or programming code associated with a particular application (e.g., backend application 108 or client application 154). Additionally, content 122 may be a particular web page, web-based application, or other web- or internet-based content. Additionally, content 122 could be a particular file type, such as a PDF, a Word document, a PowerPoint document, an image, video, audio, or any other suitable file or file type. Generally, content 122 may be anything package inside an application, and need not be web-based. For example, content 122 may be all or a portion of an application packaged and encrypted, then delivered to the user for offline use. The content 122, executed by the application, may only allow access at a time and/or location as specified by defined restrictions or behave in a modified mode during those times and/or in those locations. In some instances, the content 122 may be an application for download or execution, either locally or remotely. Additionally, content 122 may include multiple options or results based on one or more content rules 124. In other words, should a rule be satisfied, a first version of the content 122 may be provided in response to the request. Where the rule is not satisfied, a second version of the content 122 may be provided instead. If the content 122 is program code or an application, the content 122 may respond or act in a certain manner when criteria associated with the rules are satisfied and another manner when those same criteria are not satisfied. In this way, content 122 may be designed or programmed to act in a certain manner. In some instances, a first set of content 122 may be returned responsive to a request based on one or more content rules 124 based on a particular user context (e.g., time and place of the request), while a second set of content 122 may be returned responsive to an identical request made in a different user context. This may allow administrators, content providers, and designers to manage and control the behavior and access to particular content 122 in response to particular user contexts (e.g., based on the time and place of the request for particular content 122).

The content rules 124 in memory 120 can be defined to provide criteria for rules that manage and define when content 122 is available and/or how said content 122 should be presented or act in response to requests from particular user contexts. In some instances, the backend application 108 can interpret the requests received from client(s) 140, retrieve the relevant rule sets to request, and provide the corresponding content 122 according to those rules. As illustrated, the content rules 124 can include a set of time-based rules 126 and a set of location-based rules 128. Those rules can be applied separately or can be combined into a mixed rule set.

A set of authorization rules 130, as described above, can provide information on how users can generally be authorized to access particular content 122 as well as the backend application 108. The authentication rules 130 can be used by the authentication module 110 to perform general authorization and authentication functions.

Client 140 may be any computing device operable to connect to or communicate with content server 102, other clients (not illustrated), or other components via network 134, as well as with the network 134 itself, using a wireline or wireless connection, and can include a desktop computer, a mobile device, a tablet, a server, or any other suitable computer device. In general, client 140 comprises an electronic computer device operable to receive, transmit, process, and store any appropriate data associated with the environment 100 of FIG. 1. In some instances, client 140 can be a particular thing within a group of the internet of things, such as a connected appliance or tool.

As illustrated, client 140 includes an interface 142, a processor 144, a graphical user interface (GUI) 146, an NFC module 148, a GPS module 150, a location module 152, a client application 154, and memory 160. Interface 142 and processor 144 may be similar to or different than the interface 104 and processor 106 described with regard to content server 102. In general, processor 144 executes instructions and manipulates data to perform the operations of the client 140. Specifically, the processor 140 can execute some or all of the algorithms and operations described in the illustrated figures, including the operations performing the functionality associated with the client application 154 and the other components of client 140. Similarly, interface 142 provides the client 140 with the ability to communicate with other systems in a distributed environment—including within the environment 100—connected to the network 134.

Client 140 executes a client application 154. The client application 154 may operate with or without requests to the content server 102—in other words, the client application 154 may execute its functionality without requiring the content server 102 in some instances, such as by accessing particular content 162 stored locally on the client 140. In others, the client application 154 may be operable to interact with the content server 102 by sending requests via network 134 to the content server 102 for particular content 122. In some implementations, the client application 154 may be a standalone web browser, while in others, the client application 154 may be an application with a built-in browser. The client application 154 can be a web-based application or a standalone application developed for the particular client 140. For example, the client application 154 can be a native iOS application for iPad, a desktop application for laptops, as well as others. In another example, the client application 154, where the client 140 is a particular thing (e.g., device) within a group of the internet of things, may be software associated with the functionality of the thing or device. In some instances, the client application 154 may be an application that requests for dynamic or static content 122 from the content server 102 for presentation and/or execution on client 140. In some instances, client application 154 may be an agent or client-side version of the backend application 108.

In instances where the client application 154 requests for content 122 from the content server 102, the requests may include user context information associated with the client 140 at the time of the request. In particular, the client application 154 may send time and location information associated with the client 140 along with the request. The client application 154 can pull or retrieve information from one or more components, modules, applications, hardware, and/or other programs executing at the client 140 to determine the user context information. Those may include NFC module 148, GPS module 150, and location module 152. As described above, the NFC module 148 can be a combination of hardware, software, and firmware capable of using NFC technologies to determine proximity to another NFC-capable device, such as one or more sensors or NFC-capable devices associated with, while possibly remote from, the content server 102. The GPS module 150 may include hardware, software, and firmware capable of connecting with one or more global positioning satellites and identifying a longitude and latitude of the client 140. The location module 152 may be a software component or may include additional hardware and firmware components as needed. In some instances, the location module 152 may use data identified by other components of the client 140 to determine a location of the client 140, such as particular wireless networks, IP addresses assigned to the client 140, and other information. Other suitable components, whether hardware, software, or both, may be included in the client 140 to assist in determining the client's location.

The client application 154 can access some or all of the information generated by these components and use the information to request content. If the content requested is content 122 at content server 102, the information may be included in the request for said content 122. If, however, the content requested is content 162 stored locally at client 140 in memory 160, then the client application 154 may perform at least some of the calculations related to how the content 162 is to be presented or executed described previously as being performed at the content server 102.

As illustrated, client application 154 includes a content rule engine 156 for interpreting and enforcing any content rules associated with particular content 162 available locally at the client 140. Particular content 162 may be associated with one or more rules, such as time-based rules 164 and location-based rules 166. These rules may be similar to the content rules 124 and may be embedded within or associated with content 162. When the content 162 is processed for execution by the client application 154, the rules associated with the content 162 can be enforced by the content rules engine 156. In some instances, content 162 may be a particular application to be executed separately from the client application 154. In those instances, the content rules associated with content 162 may determine when and where the corresponding application can be executed and/or used.

Memory 160 may be similar to or different from memory 120 of the content server 102. In general, memory 160 can store content 162 and authorization credentials 168. The authorization credentials 168 can be provided to the content server 102 to generally authorize and authenticate the user and/or client 140 when sending requests to the content server 102.

The illustrated client 140 is intended to encompass any computing device such as a desktop computer, laptop/notebook computer, mobile device, smartphone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the client application 154 or the client 140 itself, including digital data, visual information, or a GUI 146, as shown with respect to the client 140.

While portions of the software elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

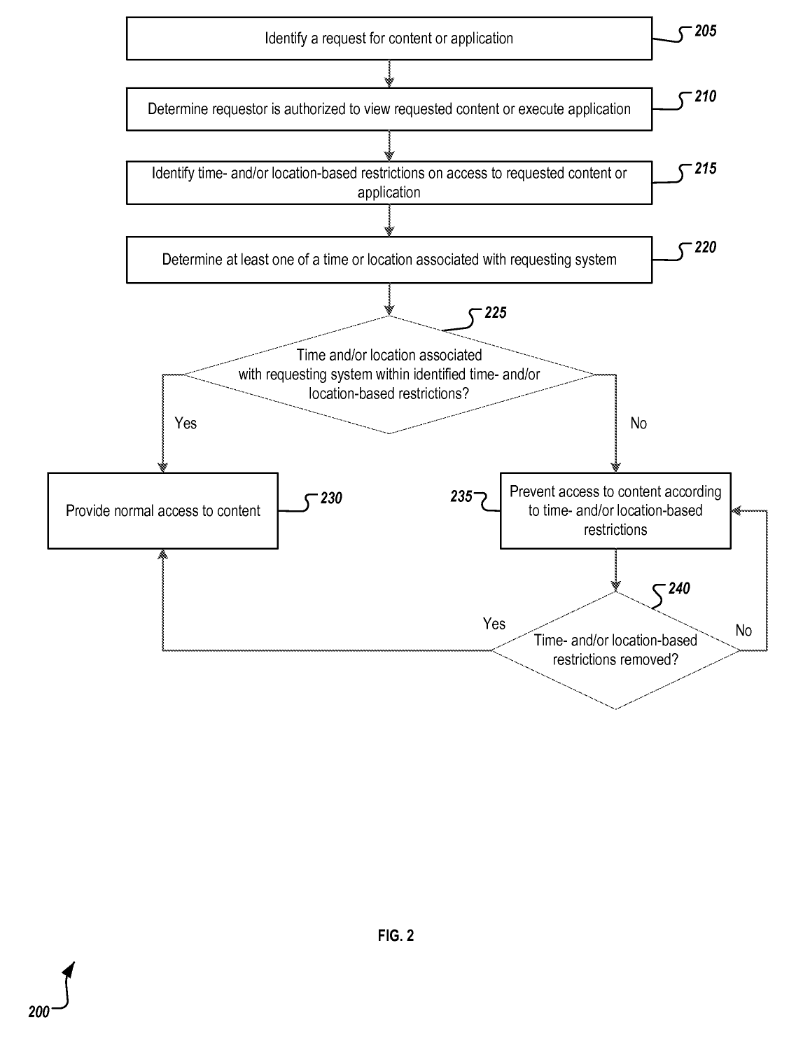

FIG. 2 is an illustration of example operations 200 performed to provide a time- and/or location-based access restriction to content based on a user context. For clarity of presentation, the description that follows generally describes method 200 in the context of the system 100 illustrated in FIG. 1. However, it will be understood that method 200 may be performed, for example, by any other suitable system, environment, software, and hardware, or a combination of systems, environments, software, and hardware as appropriate. In the described method 200, the operations may be performed locally at a client when requested content is local to the client or, alternatively, at a remote content server receiving a request from the client.

At 205, a request for particular content or the execution of a particular application is identified. As described above, the request may be a local request or may be received from a remote device or system. At 210, the requestor can be determined to be generally authorized to view the requested content or to execute the requested application.

At 215, time- and/or location-based restrictions to access of the requested content or application are identified. In some instances, the restrictions may be embedded within or otherwise associated with the requested content or application. In some instances, only one of a time-based or a location-based restriction may be associated with the requested content or application.

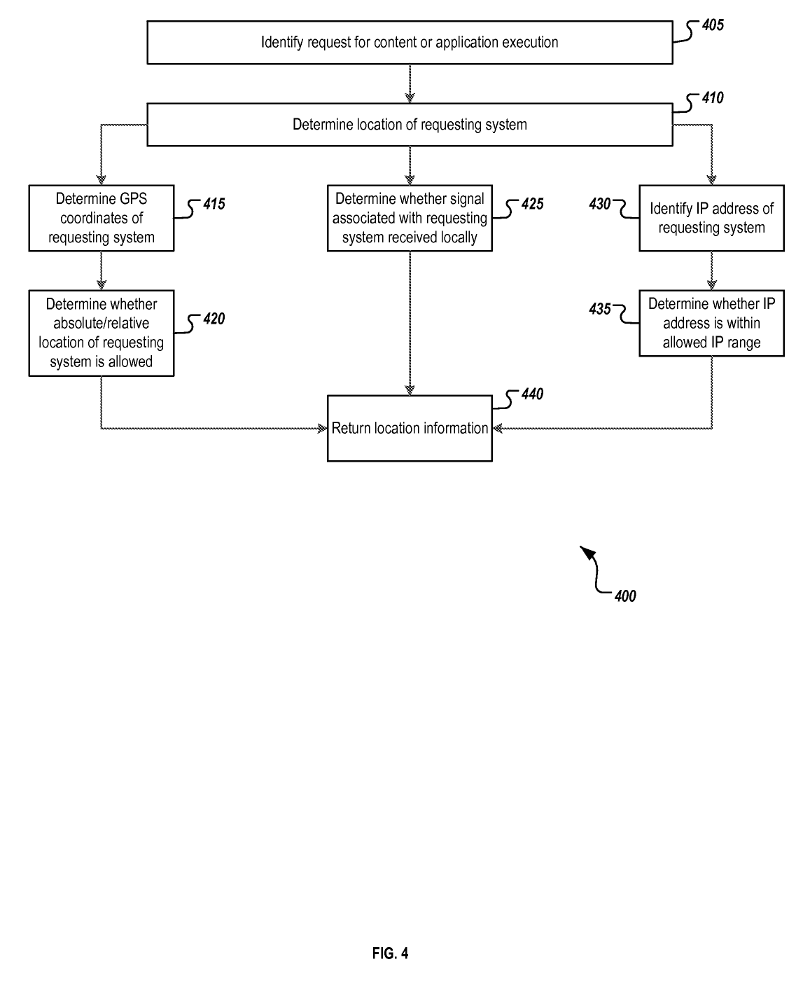

At 220, a time or location associated with the requesting system or device is determined. Any suitable technique, including those described above in relation to FIG. 1, can be used to determine the time or location of the requesting system or device. FIG. 4, described below, provides some examples of how the location of the requesting system or device may be determined. If only time-based restrictions are associated with the requested content or application, then only a time associated with the requesting system or device may need to be determined. Similarly, if only location-based restrictions are present, then only a location associated with the requesting system or device may need to be determined. Both the time and location determination may be a relative determination (e.g., the relative time at the system/device, the relative location of the system/device to a particular point or area, etc.) or an absolute determination (e.g., the time at a particular location regardless of the local time at the system/device, the longitude or latitude of the system/device, etc.).

At 225, a determination is made as to whether the time and/or location associated with the requesting system or device is within, or otherwise satisfies, the time- and/or location-based rules for access associated with the requested content or application. For purposes of the current description in FIG. 2, satisfying the time- and/or location-based rules means that access to the requested content and/or application is allowed based on the time and/or location of the requesting system or device. Thus, if the rules are satisfied, method 200 continues at 230, where normal access to the requested content or application is allowed. If, however, the rules are not satisfied, method 200 continues at 235, where access to the content is prevented according to the time- and/or location-based access restrictions. In some instances, method 200 continues from 235 to 240, where another determination is made as to whether the time- and/or location-based restrictions are to be removed, such as when an updated location or time associated with the requesting system or device is received. In some instances, this may be similar to a refreshed request (either manually from the user or automatically after a predefined or specified interval by the application), where the refreshed request can include updated time and location information. In some implementations, access may be restricted until a wholly new request for content or application execution is received, wherein method 200 begins anew. In other instances, an updated notification of a change to the location and/or the time may trigger the determination. If not, method 200 continues to prevent access at 235. If the situation changes, then method 200 moves to 230, where normal access to the requested content or application is allowed.

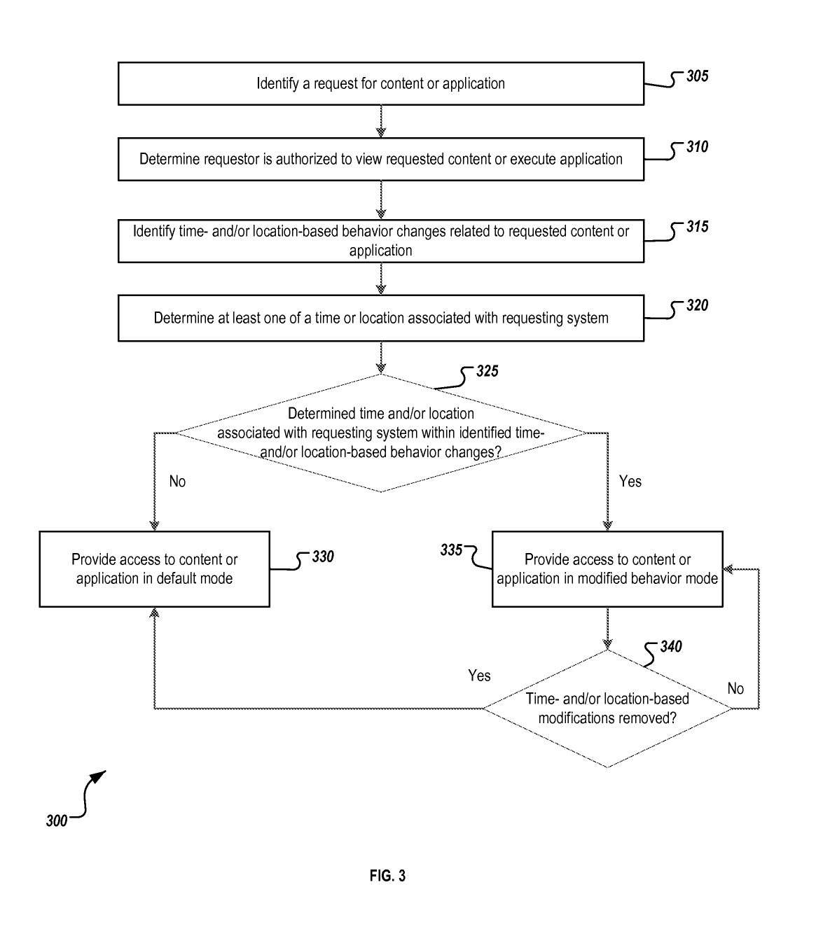

FIG. 3 is a flowchart of an example operation 300 performed to provide time- and/or location-based behavioral modifications to content and/or application operations based on a user context. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate.

At 305, a request for particular content, execution of a particular application, or access to a particular thing in the internet of things is identified. As described above, the request may be a local request or may be received from a remote device or system. At 310, the requestor can be determined to be generally authorized to view the requested content, to execute the requested application, or to access or interact with the particular thing.

At 315, time- and/or location-based behavior changes related to the requested content, application, or thing are identified. In some instances, the rules associated with the behavior changes may be embedded within or otherwise associated with the requested content, application, or programming of the thing. In some instances, only one of a time-based or a location-based behavior change may be associated with the requested content, application, or thing.

At 320, a time or location associated with the requesting system or device is determined. Any suitable technique, including those described above in relation to FIG. 1, can be used to determine the time or location of the requesting system or device. FIG. 4, described below, provides some examples of how the location of the requesting system or device may be determined. If only time-based behavior changes are associated with the requested content, application, or thing, then only a time associated with the requesting system or device may need to be determined. Similarly, if only location-based behavior changes are present, then only a location associated with the requesting system or device may need to be determined. Both the time and location determination may be a relative determination (e.g., the relative time at the system/device, the relative location of the system/device to a particular point or area, etc.) or an absolute determination (e.g., the time at a particular location regardless of the local time at the system/device, the longitude or latitude of the system/device, etc.).

At 325, a determination is made as to whether the time and/or location associated with the requesting system or device is within, or otherwise satisfies, the time- and/or location-based rules for the behavior changes associated with the requested content or application. For purposes of the current description in FIG. 3, satisfying the time- and/or location-based rules means that a modified behavior mode for the requested content and/or application is to be applied based on the time and/or location of the requesting system or device. Thus, if the rules are not satisfied, method 300 continues at 330, where a normal, or default, operation mode of operation is provided with respect to the requested content or application. Once the user is accessing content in a default mode, a later update in the time and/or location of the user or requesting device may be identified during the default operation (not shown), such that access to the modified content may be provided, or the content, application, or thing may operate in a modified behavior mode. If, however, the rules are satisfied, method 300 continues at 335, where access to the content or application is provided in a modified behavior mode based on the time- and/or location-based rules. In some instances, method 300 continues from 335 to 340, where another determination is made as to whether the time- and/or location-based behavior modifications are to be removed, such as when an updated location or time associated with the requesting system or device is received. In some instances, this may be similar to a refreshed request, (either manually from the user or automatically after a predefined or specified interval by the application), where the refreshed request can include updated time and location information. In some implementations, the behavior modifications may be maintained until a wholly new request for content or application execution is received, wherein method 300 begins anew. In other instances, an updated notification of a change to the location and/or the time may trigger the determination. If not, method 300 continues to provide access in the modified behavior mode at 335. If the situation changes, then method 300 moves to 330, where normal access to the requested content or application is allowed.

FIG. 4 is a flowchart of an example operation 400 for identifying the location of the user associated with the user context. At 405, a request for content or application execution is identified. At 410, a determination of the location of the requesting system or device is initiated. FIG. 4 provides several example techniques for doing so.

In a first example, GPS coordinates of a requesting system are determined at 415. In some instances, the GPS coordinates may be included in the identified request. In others where the GPS coordinates are not included in the request, the coordinates may be requested from the requesting system or device in response to identifying the request. Once the coordinates are determined, a determination is made at 420 as to whether the absolute or relative location of the requesting system satisfies a location-based rule for access or behavior modification. In some instances, the GPS coordinates can be used to determine if the GPS coordinates are located in a particular state, city, or area defined in the location-based rule. Upon that determination, the results on the location information can be returned at 440.

In a second example, a determination is made at 425 as to whether a signal associated with the requesting system is received locally (e.g., at a content server, or at a sensor located at a location associated with the content server and defined by the location-based rules). For example, the signal may be an RFID signal, NFC signal, or iBeacon, among others. Additionally, the signal may include an indication that the requesting system or device is on a particular wireless network. The results of the determination and the corresponding location information can be returned at 440.

In a third example, a determination is made at 430 as to an IP address associated with the requesting system or device. The IP address may be included within the request itself or may be derived in an alternative manner. At 435, a determination is made as to whether the IP address is within a particular IP range associated with locations included within a location-based rule. In some instances, such a determination may be made by accessing a third-party system providing information associating particular IP address ranges to their corresponding locations. The results of the determination and the corresponding location information can be returned at 440.

Alternative methods of determining the location of the requesting system or device may be used in other implementations. Those described herein are examples and are not meant to be limiting.

The preceding figures and accompanying description illustrate example systems, processes, and computer-implementable techniques. While the illustrated systems and processes contemplate using, implementing, or executing any suitable technique for performing these and other tasks, it will be understood that these systems and processes are for illustration purposes only and that the described or similar techniques may be performed at any appropriate time, including concurrently, individually, or in combination, or performed by alternative components or systems. In addition, many of the operations in these processes may take place simultaneously, concurrently, and/or in different orders than as shown. Moreover, the illustrated systems may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computerized method performed by one or more processors, the method comprising:
receiving a request to provide content or application access to a user;
identifying at least one behavior modification rule associated with the requested content or application access, the at least one behavior modification rule associated with a particular user context;
identifying a user context associated with the requesting user; and
in response to determining that the identified user context is within the particular user context associated with the at least one behavior modification rule, performing the at least one behavior modification rule associated with the requested content or application access.

2. The method of claim 1, wherein the particular user context associated with the at least one behavior modification rule is based on a time associated with the user context.

3. The method of claim 2, wherein the time associated with the user context is a range of time.

4. The method of claim 3, wherein the range of time is defined in a time zone relative to the requesting user.

5. The method of claim 3, wherein the at least one behavior modification rule comprises restricting access to requesting users to only outside times within the range of time, and wherein when the received request is received outside of the range of time associated with the user context of the at least one behavior modification rule, performing the at least one behavior modification rule associated with the requested content or application access comprises restricting access to the requested content or application access while outside the range of time.

6. The method of claim 3, wherein the at least one behavior modification rule comprises performing operations associated with the requested content or application access in a modified manner only at times within the range of time, and wherein when the received request is received within the range of time associated with the user context of the at least one behavior modification rule, performing the at least one behavior modification rule associated with the requested content or application access comprises performing the operations associated with the content in the modified manner while within the range of time.

7. The method of claim 1, wherein the particular user context associated with the at least one behavior modification rule is based on a location associated with the user context.

8. The method of claim 7, wherein the location associated with the user context is a location within a defined range from a particular fixed location.

9. The method of claim 7, wherein the location associated with the user context is within a geo-fenced area or within a specified distance range from a particular location.

10. The method of claim 7, wherein the location associated with the user context is a location wherein the user is able to receive a signal from a particular beacon or transmitter.

11. The method of claim 7, wherein the at least one behavior modification rule comprises applying the at least one behavior modification rule to requesting users only in locations outside the location associated with the user context, and wherein when the received request is received from outside of the location associated with the user context of the at least one behavior modification rule, performing the at least one behavior modification rule associated with the requested content or application access comprises providing the requested content or application access with modified behavior while outside the location associated with the user context.

12. The method of claim 7, wherein the at least one behavior modification rule comprises applying the at least one behavior modification rule to requesting users at the location associated with the user context.

13. The method of claim 1, wherein the identified at least one behavior modification rule is embedded within the requested content.

14. The method of claim 1, wherein the identified at least one behavior modification rule is defined within an application.

15. The method of claim 14, wherein the application is associated with presentation of the requested content.

16. The method of claim 14, wherein the application is associated with the operation of a device associated with the internet of things.

17. A non-transitory, computer-readable medium storing computer-readable instructions executable by a computer and configured to:
receive a request to provide content or application access to a user;
identify at least one behavior modification rule associated with the requested content or application access, the at least one behavior modification rule associated with a particular user context;
identify a user context associated with the requesting user; and
in response to determining that the identified user context is within the particular user context associated with the at least one behavior modification rule, perform the at least one behavior modification rule associated with the requested content or application access.

18. The computer-readable medium of claim 17, wherein the particular user context associated with the at least one behavior modification rule is based on a location associated with the user context.

19. The computer-readable medium of claim 18, wherein the at least one behavior modification rule comprises applying the at least one behavior modification rule to requesting users only in locations outside the location associated with the user context, and wherein when the received request is received from outside of the location associated with the user context of the at least one behavior modification rule, performing the at least one behavior modification rule associated with the requested content or application access comprises providing the requested content or application access with modified behavior while outside the location associated with the user context.

20. A system, comprising:
a memory;
at least one hardware processor interoperably coupled with the memory and configured to:
receive a request to provide content or application access to a user;
identify at least one behavior modification rule associated with the requested content or application access, the at least one behavior modification rule associated with a particular user context;
identify a user context associated with the requesting user; and
in response to determining that the identified user context is within the particular user context associated with the at least one behavior modification rule, perform the at least one behavior modification rule associated with the requested content or application access.
